(19) United States
(12) Patent Application Publication
(10) Pub. No.: US 2022/0101628 A1
(43) Pub. Date: Mar. 31, 2022

(54) OBJECT DETECTION AND RECOGNITION DEVICE, METHOD, AND PROGRAM

(71) Applicant: NIPPON TELEGRAPH AND TELEPHONE CORPORATION, Tokyo (JP)

(72) Inventors: Yongqing SUN, Tokyo (JP); Jun SHIMAMURA, Tokyo (JP); Atsushi SAGATA, Tokyo (JP)

(73) Assignee: NIPPON TELEGRAPH AND TELEPHONE CORPORATION, Tokyo (JP)

(21) Appl. No.: 17/422,092

(22) PCT Filed: Dec. 26, 2019
(86) PCT No.: PCT/JP2019/051148

§ 371 Date: Jul. 9, 2021

(30) Foreign Application Priority Data
Jan. 10, 2019 (JP) 2019-002803

(51) Int. Cl. G06V 20/00; G06V 10/25; G06V 10/82; G06T 3/40

(52) U.S. Cl. CPC G06V 20/00; G06T 3/40; G06V 10/82; G06V 10/25

(57) ABSTRACT

The category and region of an object shown by an image can be accurately recognized.

A first hierarchical feature map generation unit 23 Generates a hierarchical feature map constituted of feature maps hierarchized from a deep layer to a shallow layer, based on feature maps which are output by layers of the CNN. A second hierarchical feature map generation unit 24 generates a hierarchical feature map constituted of feature maps hierarchized from the shallow layer to the deep layer. As integration unit 25 generates a hierarchical feature map by integrating feature maps of corresponding layers. An object region detection unit 26 detects object candidate regions and an object recognition unit 27 recognizes, for each of the object candidate regions, the category and region of as object represented by the object candidate region.

### TECHNICAL FIELD

The present invention relates to an object detection and recognition device, a method, and a program; and more particularly to an object detection and recognition device, a method, and a program for detecting and recognizing an object in an image.

### BACKGROUND ART

Semantic image segmentation and recognition is a technique for assigning pixels in a video or image to categories. It is often applied to autonomous driving, medical image analysis, and state and pose estimation. In recent years, pixel-by-pixel image division techniques using deep learning have been actively studied. In a method called Mask RCNN (Non-Patent Literature 1), which is an example of a typical processing flow, feature map extraction of an input image is first performed through a CNN-based backbone network (part a in FIG. 6), as shown in FIG. 6. Next, is the feature map, a candidate region (region likely to be an object) related to an object is detected (part b in FIG. 6). Lastly, object position detection and pixel assignment are performed based on the candidate region (part c in FIG. 6). In addition, a hierarchical feature map extraction method called Feature Pyramid Network (FPN) (Non-Patent Literature 2) has also been proposed in which, while only the output of a deep layer of a CNN is used in feature map extraction processing of Mask RCNN, the outputs of a plurality of layers including information of a shallow layer are used as shown in FIGS. 7(A) and 7(B).

### CITATION LIST

### Non-Patent Literature

Non-Patent Literature 1: Mask R-CNN, Kaiming He, Georgia Gkioxari, Piotr Dollar, Ross Girshick, ICCV2017

Non-Patent Literature 2: Feature Pyramid Networks for Object Detection, Tsung-Yi Piotr Dollar, Ross Girshick, Kaiming He, Bharath Hariharan, and Serge Belongie, CVPR2017

### SUMMARY OF THE INVENTION

### Technical Problem

The following observations have been made regarding CNN-based object division and recognition methods.

First, in a shallow layer of the CNN-based backbone network, a low-level image feature of an input image is represented. That is, details such as lines, dots, and patterns of objects are represented.

Second, at a deeper CNN layer, a higher-level feature of the image can be extracted. For example, features that represent the characteristic contours of objects and the contextual relationships between objects can be extracted.

In the Mask RCNN method which is presented in the above-described Non-Patent Literature 1, the next object region candidate detection and segmentation for each pixel are performed by using only a feature map generated from the deep layer of the CNN. Therefore, the low-level feature amount that represents details of objects are lost, which causes problems in which an object detection position deviates and the accuracy of segmentation (assignment of pixels) is reduced.

On the other hand, in the FPN method in Non-Patent Literature 2, semantic information is propagated to a shallow layer while being upsampled from a feature map of a deep layer in the CNN backbone network. Then, object division is performed by using a plurality of feature maps and thereby an object division accuracy is improved to some degree; however, since a low-level feature is not actually incorporated into a high-level feature map (up layer), a problem with accuracy in object division and recognition occurs.

The present invention has been made in order to solve the above-mentioned problems and it is an object of the present invention to provide an object detection and recognition device, a method, and a program that allow the category and region of an object represented by an image to be accurately recognized.

### Means for Solving the Problem

In order to achieve the above-mentioned object, an object detection and recognition device according to a first invention includes: a first hierarchical feature map generation unit that inputs an image to be recognized into a Convolutional Neural Network (CNN) and generates a hierarchical feature map which is constituted of feature maps hierarchized from a deep layer to a shallow layer, based on feature maps which are output by layers of the CNN; a second hierarchical feature map generation unit that generates a hierarchical feature map which is constituted of feature maps hierarchized from the shallow layer to the deep layer, based on the feature maps which are output by the layers of the CNN; an integration unit that generates a hierarchical feature map by integrating feature maps of corresponding layers in the hierarchical feature maps constituted of the feature maps hierarchized from the deep layer to the shallow layer and the hierarchical feature map constituted of the feature maps hierarchized from the shallow layer to the deep layer; an object region detection unit that detects object candidate regions based on the hierarchical feature map generated by the integration unit; and an object recognition unit that recognizes, for each of the object candidate regions, the category and region of an object which is represented by the object candidate region, based on the hierarchical feature map generated by the integration unit.

In addition, it is applicable that: in the object detection and recognition device according to the firs t invention, the first hierarchical feature map generation unit calculates feature maps in order from the deep layer to the shallow layer and generates a hierarchical feature map which is constituted of the feature maps calculated in order from the deep layer to the shallow layer; the second hierarchical feature map generation unit calculates feature maps in order from the shallow layer to the deep layer and generates a hierarchical feature map which is constituted of the feature maps calculated in order from the shallow layer to the deep layer; and the integration unit integrates feature maps whose orders correspond to each other, thereby generating a hierarchical feature map. In addition, it is applicable that: the first hierarchical feature map generation unit obtains, in order from the deep layer to the shallow layer, feature maps each of which is calculated such that a feature map which is obtained by upsampling a last feature map calculated before a target layer and a feature map which is output by the target layer are added together, and generates a hierarchical feature map which is constituted of the feature maps calculated in order from the deep layer to the shallow layer; and the second hierarchical feature map generation unit obtains, in order from the shallow layer to the deep layer, feature maps each of which is calculated such that a feature map which is obtained by downsampling a last feature map calculated before a target layer and a feature map which is output by the target layer are added together, and generates a hierarchical feature map which is constituted of the feature maps calculates in order from the shallow layer to the deep layer.

In addition, it is applicable that in the object detection and recognition device according to the first invention, the object recognition unit recognizes, for each of the object candidate regions, the category, position, and region of an object which is represented by the object candidate region, based on the hierarchical feature map generated by the integration unit.

In an object detection and recognition method according to a second invention, a first hierarchical feature map generation unit inputs an image to be recognized into a Convolutional Neural Network (CNN) and generates a hierarchical feature map that is constituted of feature maps hierarchized from a deep layer to a shallow layer, based on feature maps which are output by layers of the CNN; a second hierarchical feature map generation unit generates a hierarchical feature map that is constituted of feature maps hierarchized from the shallow layer to the deep layer, based on the feature maps which are output by the layers of the CNN; an integration unit generates a hierarchical feature map by integrating feature maps of corresponding lavers in the hierarchical feature map that is constituted of the feature maps hierarchized from the deep layer to the shallow layer and the hierarchical feature map that is constituted of the feature maps hierarchized from the shallow layer to the deep layer; an object region detection unit detects object candidate regions based on the hierarchical feature map generated by the integration unit; and an object recognition unit recognizes, for each of the object candidate regions, the category and region of an object which is represented by the object candidate region, based on the hierarchical feature map generated by the integration unit.

A program according to a third invention is a program for causing a computer to function as each part of the object detection and recognition device according to the first invention.

### Effects of the Invention

According to the object detection and recognition device, the method, and the program of the present invention, a hierarchical feature map constituted of feature maps hierarchized from a deep layer to a shallow layer and feature maps hierarchized from a shallow layer to a deep layer are generated based on a feature map which is output by layers of the CNN; a hierarchical feature map is generated by integrating feature maps of corresponding layers; object candidate regions are detected; and for each of the object candidate regions, the category and region of an object represented by the object candidate region are recognized; thereby obtaining the effect of allowing accurate recognition of the category and region of the object represented by an image.

### BRIEF DESCRIPTION OF DRAWINGS

FIG. 1 is a block diagram showing the configuration of an object detection and recognition device according to an embodiment of the present invention.

FIG. 2 is a flow chart showing an object detection and recognition processing routine in the object detection and recognition device according to the embodiment of the present invention.

FIG. 3 is a diagram for describing a method for generating a hierarchical feature map and a method for integrating hierarchical feature maps.

FIG. 4 is a diagram for describing bottom-up augmentation processing.

FIG. 5 is a diagram for describing a method for detecting and recognizing an object.

FIG. 6 is a diagram for describing prior art Mask RCNN processing.

FIG. 7(A) is a diagram for describing prior art FPN processing and FIG. 7(B) is a diagram for describing a method for generating feature maps hierarchized from a deep layer to a shallow layer by upsampling processing.

### DESCRIPTION OF EMBODIMENTS

Hereinafter, an embodiment of the present invention will be described in detail with reference to the drawings.

### Outline According to Embodiment of Present Invention

First, an outline of the embodiment of the present invention will be described.

In view of the above-mentioned problems, it is considered that in a feature-extraction CNN-based backbone network, if a well-balanced bidirectional information propagation path for both information propagation from a shallow layer and information propagation from a deep layer is used, it is effective for accurate object detection and recognition.

Therefore, in the embodiment of the present invention, an image where object detection and recognition are to be performed is obtained and for the image, feature maps hierarchized from a deep layer are generated through a CNN backbone network by an FPN, for example, and feature maps hierarchized from a shallow layer are generated by a reversed FPN in an image CNN backbone network. Furthermore, the generated feature maps hierarchized from a deep layer and the feature maps hierarchized from a shallow layer are integrated to generate a hierarchical feature map, and object detection and recognition are performed by using the generated hierarchical feature map.

### Configuration of Object Detection and Recognition Device According to Embodiment of Present Invention

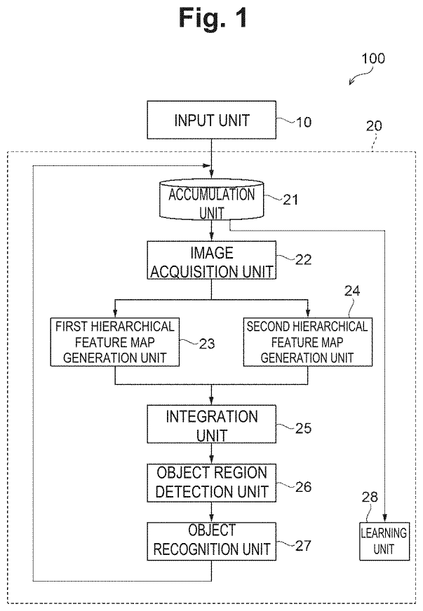

Next, the configuration of the object detection and recognition device according to the embodiment of the present invention will be described. As shown in FIG. 1, an object detection and recognition device 100 of the embodiment of the present invention can be constituted of a computer including a CPU, a RAM, and an ROM in which programs and various kinds of data for executing an object detection and recognition processing routine described later are stored. This object detection and recognition device 100 functionally includes an input unit 10 and an arithmetic unit 20, as shown in Fig

The arithmetic unit 20 includes an accumulation unit 21, an image acquisition unit 22, a first hierarchical feature map generation unit 23, a second hierarchical feature map generation unit 24, an integration unit 25, an object region detection unit 26; an object recognition unit 27, and a learning unit 28.

In the accumulation unit 21, images that are targets of object detection and recognition are accumulated. The accumulation unit 21 outputs, when receiving a processing instruction from the image acquisition unit 22, an image to the image acquisition unit 22. In addition, a detection result and a recognition result which are obtained by the object recognition unit 27 are stored in the accumulation unit 21. Note that at the time of learning, images each provided with a detection result and a recognition result in advance have been stored in the accumulation unit 21.

The image acquisition unit 22 outputs a processing instruction to the accumulation unit 21, obtains an image stored in the accumulation unit 21, and outputs the obtained image to the first hierarchical feature map generation unit 23 and the second hierarchical feature map generation unit 24.

The first hierarchical feature map generation unit 23 receives the image from the image acquisition unit 22, inputs the image to a Convolutional Neural Network (CNN), and generates a hierarchical feature map constituted of feature maps hierarchized from a deep layer to a shallow layer, based on feature maps which are output by layers of the CNN. The generated hierarchical feature map is output to the integration unit 25.

The second hierarchical feature map generation unit 24 receives the image from the image acquisition unit 22, inputs the image to the Convolutional Neural Network (CNN), and generates a hierarchical feature map constituted of feature maps hierarchized from the shallow layer to the deep layer, based on feature maps which are output by the layers of the CNN. The generated hierarchical feature map is output to the integration unit 25.

The integration unit 25 receives the hierarchical feature map generated by the first hierarchical feature map generation unit 23 and the hierarchical feature map generated by the second hierarchical feature map generation unit 24; and performs integration processing.

Specifically, the integration unit 25 integrates feature maps of corresponding layers in the hierarchical feature map which is generated by the first hierarchical feature map generation unit 23 and constituted of feature maps hierarchized from the deep layer to the shallow layer, and the hierarchical feature map which is generated by the second hierarchical feature map generation unit 24 and constituted of feature maps hierarchized from the shallow layer to the deep layer; and thereby generates a hierarchical feature map and outputs it to the object region detection unit 26 and the object recognition unit 27.

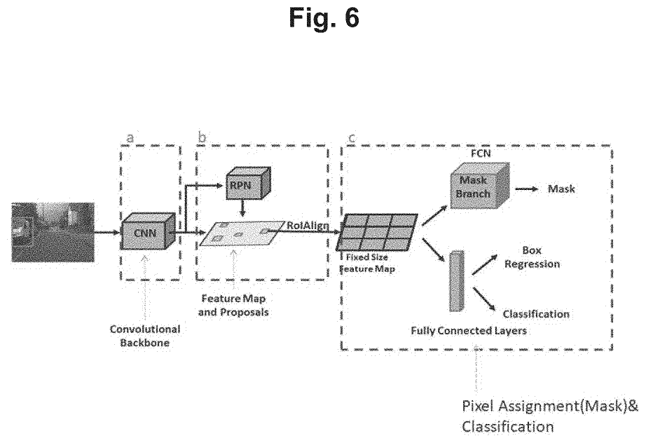

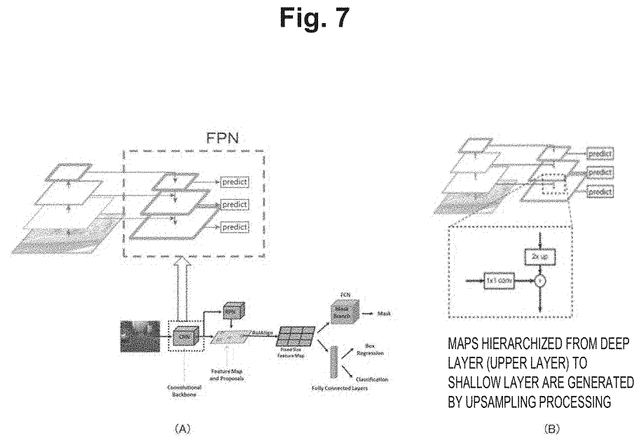

The object region detection unit 26 detects object candidate regions by performing pixel-by-pixel object division for the input image by using a deep-learning-based object detection (for example, processing b of Mask RCNN shown in FIG. 6), based on the hierarchical feature map generated by the integration unit 25.

The object recognition unit 27 recognizes, for each of the object candidate regions, the category, position, region of an object represented by the object candidate region by using a deep-learning-based recognition method (for example, processing c of mask RCNN shown in FIG. 6), based on the hierarchical feature map generated by the integration unit 25. The recognition result of the category, position, and region of the object is stored in the accumulation unit 21.

The learning unit 28 learns neural network parameters which are used by each of the first hierarchical feature map generation unit 23, the second hierarchical feature map generation unit 24, the object region detection unit 26, and the object recognition unit 27, by using both a result of recognizing, by the object recognition unit 27, each of images which are provided with a detection result and a recognition result in advance, and the detection result and recognition result which are provided for the each of images in advance, both of which are stored in the accumulation unit 21. It is only required that for learning, a general learning method for neural networks such as a backpropagation method is used. Learning by the learning unit 28 allows each of the first hierarchical feature map generation unit 23, the second hierarchical feature map generation unit 24, the object region detection unit 26, and the object recognition unit 27 to perform processing using a neural network whose parameters have been tuned.

Note that processing of the learning unit 28 needs only to be performed at any timing, separately from a series of object detection and recognition processing which is performed by the image acquisition unit 22, the first hierarchical feature map generation unit 23, the second hierarchical feature map generation unit 24, the integration unit 25, the object region detection unit 26, and the object recognition unit 27.

### Function of Object Detection and Recognition Device According to Embodiment of Present Invention

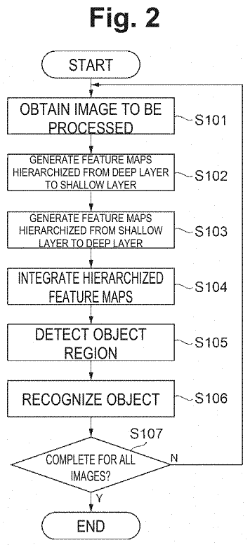

Next, the function related to object detection and recognition in the object deter ton and recognition device 100 according to the embodiment of the present invention will be described. The object detection and recognition device 100 executes an object detection and recognition processing routine shown in FIG. 2.

First, at step S101, the image acquisition unit 22 outputs a processing instruction to the accumulation unit 21 and obtains an image stored in the accumulation unit 21.

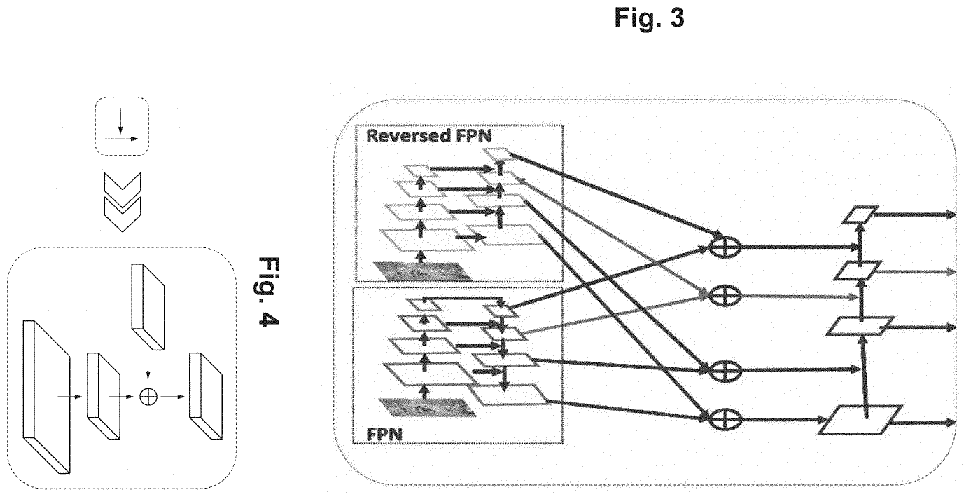

Next, at step S102, the first hierarchical feature map generation unit 23 inputs an image obtained at the above step S101 into a CNN-based backbone network and obtains feature maps which are output from layers. Here, it is only required that a CNN network such as VGG or Resnet is used. Then, by a data augmentation method shown in an FPN of FIG. 3, feature maps are obtained in order from a deep layer to a shallow layer and a hierarchical feature map constituted of the feature maps calculated in order from the deep layer to the shallow layer is generated. In this case, in calculating feature maps in order from the deep layer to the shallow layer, the feature maps are calculated by adding together a feature map which is obtained by upsampling a last feature map calculated before a target layer and a feature map which is output by the target layer so as to be processing opposite to processing shown in FIG. 4.

In such a hierarchical feature map, semantic information (characteristic contour of an object, context information between objects) of an up layer can be propagated also to a lower feature map, so that in object detection, such effects as obtaining a smooth object contour, having no detection missing, and providing a good accuracy can be expected.

At step S103, the second hierarchical feature map generation unit 24 inputs the image obtained at the above step S101 into the CNN-based backbone network as with step S102 and obtains feature maps which are output from the layers. Then, as shown in a Reversed FPN of FIG. 3, feature maps are obtained in order from the shallow layer to the deep layer, and a hierarchical feature map constituted of the feature maps calculated in order from the shallow layer to the deep layer is generated. In this case, in calculating feature maps in order from the shallow layer to the deep layer, the feature maps are calculated by adding together a feature map which is obtained by downsampling a last feature map calculated before a target layer and a feature map which is output by the target layer, as shown in FIG. 4 described above.

Such feature maps allow detailed information on objects (information such as lines, dots, patterns) to be propagated also to a feature map at an up layer; and in object division, such effects as obtaining a more accurate object contour and being able to detect an especially small-sized object without missing can be expected.

At step S104, the integration unit 25 generates a hierarchical feature map by performing integration such that feature maps whose orders correspond to each other are added together, as shown in FIG. 3. In this case, using a data augmentation method (bottom-up augmentation) as with FIG. 4 described above, feature maps are obtained in order from a lower layer by performing calculation such that a feature map which is obtained by downsampling a last feature map calculated before a target layer and a feature map which is obtained by addition at the target layer, so that a hierarchical feature map constituted of the feature maps calculated in order is generated.

Note that while the above description has been made by using, as an example, a case where a data augmentation method is used, other integration method may be implemented. For example, integration may be performed so as to take an average between feature maps whose orders correspond to each other; or integration may be performed so as to take a maximum value between feature maps whose orders correspond to each other. Alternatively, integration may be performed so as to simply add feature maps whose orders correspond to each other. Furthermore, integration may be performed by addition for weighing. For example, when a subject has a certain size or larger on a complicated background, a larger weight may be assigned to a feature map obtained at the above step S102. In addition, when a plurality of small-sized subjects exist in an image, a larger weight may be assigned to a feature map obtained at the above step S103 which emphasizes a low-level features. Furthermore, integration may be performed by using a data augmentation method different from the one in FIG. 4 described above.

At step S105, the object region detection unit 26 detects each of the object candidate regions based on the hierarchical feature map generated at the above step S104.

For example, for the feature map of each layer, the score of abjectness is calculated for each pixel by a Region Proposal Network (RPN) and an object candidate region where a score in a corresponding region at each layer is high is detected.

At step S106, the object recognition unit 27 recognizes, for each of the object candidate regions detected by the above step S105, the category, position, and region of an object which is represented by the object candidate region, based on the hierarchical feature map generated at the above step S104.

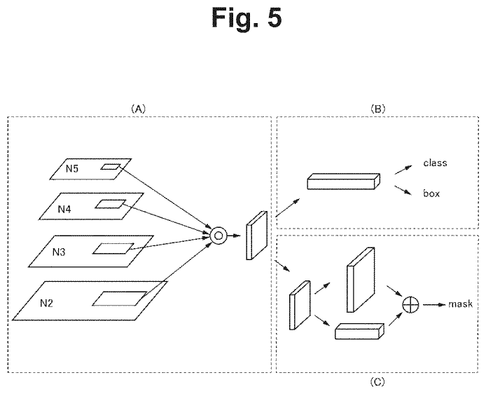

For example, the object recognition unit 27 generates, as shown in FIG. 5(A), a fixed size feature map by using each of portions corresponding to the object candidate regions in the feature map of each of the layers of the hierarchical feature map. In addition, the object recognition unit 27 inputs, as shown in FIG. 5(C), the fixed size feature map to a Fully Convolutional Network (FCN). Thus, the object recognition unit 27 recognizes an object region represented by the object candidate region. In addition, the object recognition unit 27 inputs the fixed size feature map into a fully connected layer as shown in FIG. 5(B). Thus, the object recognition unit 27 recognizes the category of the object represented by the object candidate region and the position of a box surrounding the object. Then, the object recognition unit 27 stores the recognition results of the category, position, and region of the object which is represented by the object candidate region, to the accumulation unit 21.

At step S107, whether processing for all images stored in the accumulation unit 21 is complete is determined and if it is complete, the object detection and recognition processing routine ends; if it is not complete, the process returns to step S101, where the next image is obtained and the processing is repeated.

As described above, the object detection and recognition device according to the embodiment of the present invention generates a hierarchical feature map constituted of feature maps hierarchized from a deep layer to a shallow layer and a hierarchical feature map constituted of feature maps hierarchized from the shallow layer to the deep layer, based on feature maps which are output by the layers of the CNN, generates a hierarchical feature map by integrating feature maps of corresponding layers, detects object candidate regions, and recognizes, for each of the object candidate regions, the category and region of an object represented by the object candidate region, thereby allowing the category and region of an object represented by an image to be accurately recognized.

In addition, it is possible to achieve an effective use of both a high-level feature (upper layer) that represents semantic information of an object and a low-level feature (lower layer) that represents detailed information of the object, which are information of all convolutional layers in the CNN network; and therefore, more accurate object division and recognition can be performed.

Note that the present invention is not limited to the above-described embodiment, and various modifications and applications are possible without departing from the gist of the present invention.

For example, in the above-described embodiment, description has been made by using, as an example, a case where the learning unit 28 is included in the object detection and recognition device 100; however, it is not limited thereto and may be configured as a learning device separate from the object detection and recognition device 100.

### REFERENCE SIGNS LIST

10 Input unit
20 Arithmetic unit
21 Accumulation unit
22 Image acquisition unit
23 First hierarchical feature map generation unit
24 Second hierarchical feature map generation unit
25 Integration unit
26 Object region detection unit
27 Object recognition unit
28 Learning unit
100 Object detection and recognition device

1. An object detection and recognition device, comprising:
a first hierarchical feature map generator configured to input an image to be recognized into a Convolutional Neural Network (CNN) and generate a hierarchical feature map based on feature maps that are output by layers of the CNN, the hierarchical feature map being constituted of the feature maps hierarchized from a deep layer to a shallow layer;
a second hierarchical feature map generator configured to generate a hierarchical feature map based on the feature maps which are output by the layers of the CNN, the hierarchical feature map being constituted of the feature maps hierarchized from the shallow layer to the deep layer;
an integrator configured to generate a hierarchical feature map by integrating feature maps of corresponding layers in both the hierarchical feature map constituted of the feature maps hierarchized from the deep layer to the shallow layer and the hierarchical feature map constituted of the feature maps hierarchized from the shallow layer to the deep layer;
an object region detector configured to detect object candidate regions based on the hierarchical feature map generated by the integrator; and
an object recognizer configured to recognize, for each of the object candidate regions, a category and region of an object which is represented by the object candidate region based on the hierarchical feature map generated by the integrator.

2. The object detection and recognition device according to claim 1, wherein
the first hierarchical feature map generator calculates feature maps in order from the deep layer to the shallow layer and generates a hierarchical feature map constituted of the feature maps calculated from the deep layer to the shallow layer;
the second hierarchical feature map generator calculates feature maps in order from the shallow layer to the deep layer and generates a hierarchical feature map constituted of the feature maps calculated from the shallow layer to the deep layer; and
the integrator integrates feature maps, orders of the feature maps corresponding to each other, thereby generating a hierarchical feature map.

3. The object detection and recognition device according to claim 2, wherein:
the first hierarchical feature map generator obtains feature maps in order from the deep layer to the shallow layer and generates a hierarchical feature map that is constituted of the feature maps calculated in order from the deep layer to the shallow layer, each of the feature maps being calculated such that a feature map which is obtained by upsampling a last feature map calculated before a target layer and a feature map which is output by the target layer are added together, and
the second hierarchical feature map generator obtains feature maps in order from the shallow layer to the deep layer and generates a hierarchical feature map that is constituted of the feature maps calculated in order from the shallow layer to the deep layer, each of the feature maps being calculated such that a feature map which is obtained by downsampling a last feature map calculated before a target layer and a feature map which is output by the target layer are added together.

4. The object detection and recognition device according to claim 1, wherein:
the object recognition unit recognizes, for each of the object candidate regions, category, position, and region of an object that is represented by the object candidate region, based on the hierarchical feature map generated by the integration unit.

5. An object detection and recognition method, the method comprising:
inputting, by a first hierarchical feature map generator, inputs an image to be recognized into a Convolutional Neural Network (CNN) and generating a hierarchical feature map that is constituted of feature maps hierarchized from a deep layer to a shallow layer, based on feature maps which are output by layers of the CNN;
generating, by a second hierarchical feature map generator, a hierarchical feature map that is constituted of feature maps hierarchized from the shallow layer to the deep layer, based on the feature maps which are output by the layers of the CNN;
generating, by an integrator, a hierarchical feature map by integrating feature maps of corresponding layers in the hierarchical feature map that is constituted of the feature maps hierarchized from the deep layer to the shallow layer and the hierarchical feature map that is constituted of the feature maps hierarchized from the shallow layer to the deep layer;
detecting, by an object region detector, object candidate regions based on the hierarchical feature map that is generated by the integrator; and
recognizing, by an object recognizer, for each of the object candidate regions, a category and region of an object that is represented by the object candidate region, based on the hierarchical feature map generated by the integrator.

6. A program for causing a computer to function as each part of the object detection and recognition device according to claim 1.

7. The object detection and recognition device according to claim 2, wherein:
the object recognition unit recognizes, for each of the object candidate regions, category, position, and region of an object that is represented by the object candidate region, based on the hierarchical feature map generated by the integration unit.

8. The object detection and recognition device according to claim 3, wherein:
the object recognition unit recognizes, for each of the object candidate regions, category, position, and region of an object that is represented by the object candidate region, based on the hierarchical feature map generated by the integration unit.
